(19) United States
(12) Patent Application Publication
(10) Pub. No.: US 2006/0129879 A1
(43) Pub. Date: Jun. 15, 2006

(54) System and method for monitoring the status and progress of a technical process or of a technical project

(75) Inventors: Richard Alznauer, Ellerstadt (DE); Andreas Liefeldt, Lunen (DE); Georg Gutermuth, Heidelberg (DE); Stefan Basenach, Neustadt (DE); Peter Beer, Mannheim (DE)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: ABB Patent GmbH, Ladenburg (DE)

(21) Appl. No.: 11/271,927

(22) Filed: Nov. 14, 2005

(30) Foreign Application Priority Data
Nov. 15, 2004 (DE) 10 2004 055 107.3

(51) Int. Cl. G06F 11/00

(52) U.S. Cl. 714/10

(57) ABSTRACT

The invention relates to a system and method for automatically and systematically analysing and monitoring operations of a technical process (10) for the status and progress monitoring of the technical process (10), based on data (D) which characterizes the current state of the process (10), in which check routines (C) for describing and implementing check criteria for evaluating the data (D) are defined and stored in a first module (20). The first module (20) interacts with a second module (30) which compiles the check routines (C) stored in the first module (D) to form hierarchically structured check points (CP). The check routines (C) which are stored in the hierarchically structured check points (CP) check, by assigning the data (D). made available by the process (10) and by taking into account the results of the check routines (C) carried out by the subordinate check points (CP), whether the check criteria stored in the check routines (C) apply, carry out automatic evaluation of the check routines (C) and generate information about the status and/or progress of the respective process.

The invention relates to a system and method for automatically and systematically analysing and monitoring operations of a technical process or of a technical project on the basis of data which characterizes the current state of the project or process, according to claims 1 and 10, and is particularly suitable for monitoring status and progress in planning the production engineering or instrumentation and control engineering aspects of production engineering systems.

In order to plan a technical system, the sequencing of an industrial process or of a technical project, referred to below as process, it is necessary as far as possible to obtain an overview of the current status or the progress of the process at every point in time in order, for example, to implement complex investment projects and complex technical processes with an effective use of resources within a predefined time and cost frame.

In order to be able to call current information about the status of the process at any time, a clearly structured and informative reporting. system, for example in the form of reports, must be present for this purpose.

In particular in relatively large engineering projects, the tracking of projects is associated with considerable administrative expenditure which depends on working sequences or working processes which are divided into different working packages. The number and the scope of the working packages constitute here a significant influencing variable on the successful monitoring of the progress of the project.

The currently used methods for analysing and monitoring the progress of processes operate in a way which is oriented towards time, budget or costs. In order to manage and visualize the status data and progress data, a separate database which is independent of the process data, project data, production data or system data is usually maintained and managed by independent software. As a result this takes a considerable amount of additional time.

In order to analyse and control a complex process, customarily predefined resources such as, for example, timescales, predefined costs and workers are assigned to the process which is divided into individual work packages or subprojects, and are stored in existing plans for subsequent analysis.

The analysis methods which are used in this context use work breakdown structures or project structure plans which divide the process into various work packages of a relatively low complexity in order to analyse the process more easily.

During the running time of a project, the existing timescales are used up, for example as a result of simple hourly recording by assigning the working performance with to-the-hour accuracy to a planned work package, thus permitting cost-based determination of the current status or progress of the project.

In addition to or as an alternative to maintaining timescales, it is also possible for documents to provide records of the work steps which have been carried out. For this purpose, the documents are standardized in advance so that information can be transferred from one project phase to the next and at the same time the progress of the project is documented in an event-based fashion in a way which can be traced at a later time.

A further currently used approach to a solution for analysing and monitoring operations of technical projects is based on the structured and regular collection of information, for example by questioning the employees involved in the project and by subsequent computer-supported evaluation of the collected information, but this progress-based approach takes a considerable amount of time, in particular if projects are implemented in a worldwide team.

The described methods and procedures for analysing and monitoring operations of technical projects or industrial processes require continuous maintenance of an external database in order to assess the status or the progress of a process. In such a case, the data must be input manually which is time-consuming or be derived from another database such as, for example, an hourly account. In particular, the maintenance and use of external data storage software which is necessary for this purpose entails additional costs due to the need to train employees and as a result of the accompanying data maintenance.

However, the analysis and monitoring of the status and progress of the process prove problematic in particular if the available information or data is subject to a certain extent to estimations which cause the analyses which are carried out to be subject to large degrees of uncertainty and to be inaccurate.

Furthermore, it is not possible to carry out spontaneous interrogation of the status of the process at any desired time without relatively large response times which describe the time between a status enquiry and the corresponding response. In particular in the case of technical projects which operate with a large quantity of data, a distorted view of the status of the process and/or progress of the process occurs as a result of an operation-based approach, for example as a result of hourly recording, related to subprocesses. Data-based analysis or monitoring of the respective operations is not possible since only the timescales are considered and there is no information provided about the actual work progress. The information here is derived information.

Taking the prior art as a starting point, the invention is based on the object of specifying a system and a method for automatically and systematically analysing the status of and monitoring operations and/or sequences of a technical process or project which permits the abovementioned disadvantages of the prior art to be overcome.

This object is achieved according to the invention by means of a system of the type mentioned at the beginning having the features specified in claim 1. Advantageous refinements and improvements of the system according to the invention and a method are specified in further claims and in the description.

The system according to the invention for automatically and systematically analysing and monitoring operations or sequences of a technical process or of a technical project, referred to below as process, is based on data which characterizes the current state of the process, and is suitable in particular for monitoring status and progress in data-driven planning processes such as, for example, the planning aspect of production engineering and instrumentation and control engineering.

In order to assess the status or progress of a process, the data which characterizes the process, referred to below also as process data, project data, production data or system data, is evaluated by means of what are referred to as checks. For this purpose, the check routines, which describe any check criteria for data of different process sections in an abstract way, are defined and stored in a first module which is present in the system according to the invention.

The check routines are defined independently of the project data, process data, production data or system data and contain an abstract description of the data to be checked. For example, the check routines are capable of checking the presence of information about objects, for example temperature measurements, step-by-step programs and switching cabinets, documents, for example current diagrams, data sheets, functional description, acceptance records and drawings or of attributes, for example size, weight, performance and order number.

The data in this context comprises one or more attributes of an object type, the revision of an object type or the existence of connections to other objects. The criteria which are integrated in the check routines check for the existence of data, data objects and/or attributes of the data objects. For example, in this context the status of attributes is checked to determine whether or not they are set. Document properties such as the size, the revision status or the presence of the documents are also checked.

The first module interacts with a second module which compiles the previously defined check routines to form hierarchically structured check points. The structure of the check points is in turn acquired here by a freely selectable hierarchical depth of nested check points.

In the hierarchically structured check points, the defined check criteria check the technical completeness of the data which is made available by the process and which is preferably compiled to form data objects, taking into account the results of the check routines carried out by the respectively subordinate check points, and thus check whether the check criteria stored in the check routines apply. After automatic evaluation of the check routines, the checked data which characterizes the current state or the progress of the process can be presented by means of an output unit.

For status interrogations, the hierarchically structured check points condition the checked data of the respectively subordinate check points for the superordinate check points. During the conditioning of the data, the information is compressed (aggregation) and the respectively selected check point produces a report for the output unit.

As a result, the check points advantageously combine the results of the defined check routines. By means of a specified relationship between the check routines and the data and/or data objects a definition is made of which checks are applied to which data. When a check point is evaluated, the check criteria of the check routines are applied to all the assigned objects and the results of each check routine are buffered as information about the status and/or progress of the respective process in the respective check point for further processing and evaluation. Check routines which cannot be applied to the corresponding object type are jumped over in this context.

After all the data or objects have been checked completely, information about the status and/or progress of the respective process is generated, compressed and preferably presented in the form of a compiled report by means of the evaluation unit.

There is also provision for the information about the progress of the respective process to be made available for further processing, for example for management reports.

The information about the status and/or progress of the respective process is presented, for example, by means of coloured characterization of the information about the status and/or progress of the respective process in conjunction with the assigned objects, in particular as a tabular or matrix representation. The use of coloured characterization advantageously simplifies rapid identification of failed checks or checks which have been passed.

Since a large number of data objects have to be collected and processed in technical projects or industrial processes and a simple unstructured list of check points would quickly become unmanageable, the check points are structured hierarchically to any desired depth. As a result, any desired number of check points can be presented in a manageable way and a check can be carried out at any desired stage of the check point hierarchy. Since the hierarchically structured check points compress the information about the respective process status of the respectively subordinate check points and pass on the information about the status and/or progress of the respective process in a compiled form to the respectively subordinate check points, the information about the status and/or progress of the respective process of a respectively structured check point can be visualized in a tree hierarchy, for example by means of the coloured characterization described above.

A further advantage of the invention is based on the fact that the hierarchical structuring of the check points is not subject to any defined rules and the structure of the check points can be divided into any desired number of hierarchy levels. The check criteria can thus be managed in parallel according to different criteria and check routines can be carried out at any desired points in time within the process sequence. Examples of this are chronological relationships, process engineering relationships or local relationships. Likewise, the data objects can be assigned to any desired number of check points so that checking is carried out in different contexts.

The systematic analysis and evaluation of the process data, production data or system data thus advantageously permits information to be obtained about the status at a particular time, for example the technical completeness of the data present, and, derived from this data, information about the status and/or progress of the respective process, irrespective of the call time and the inputs or information provided by the employees working on the project.

Apart from the project data, production data or process data which is made available by the process, the monitoring of status and progress of the ongoing process which is carried out by the system according to the invention does not require any further information to determine the status at a particular time. In addition it is not necessary to input or generate additional data manually.

Since the analysis and checking of the data is carried out solely by means of available data, there is no need for estimations or predictions about missing information, and uncertainties with respect to the determination of the precise status or progress of the process are avoided.

The method with which the object is furthermore solved can be found in claim 10. Here, check routines for evaluating the data which is made available by the process and which is preferably compiled to form data objects are defined and stored by means of a first module, with the check routines describing any desired check criteria for the data objects of a process or project.

By means of a second module, a hierarchical check point structure is generated and the check routines which are stored in the first module are assigned to the check points. Here, a check routine (check) can be assigned to any desired number of check points. In the hierarchically structured check points, the technical completeness of the data is checked, the check routines are evaluated automatically and information about the status and/or progress of the respective process is generated by means of automatic iteration by means of the check routines using the data made available by the process and taking into account the results of the check routines which are carried out by the subordinate check points.

The implementation of a superordinate check point automatically takes into account the implementation of subordinate check points, with the evaluation information being propagated to subordinate check routines and check points as far as the implemented check point.

With the method according to the invention it is advantageously possible to implement one or more check points either manually or else in an automated fashion.

The method on which the invention is based is not operation-oriented since chronological sequences are not predefined or prescribed for calling the information about the current status and progress of the process.

The information about the status and/or progress of the respective process is transferred to an output unit which conditions the information in the form of a compiled report and presents it in such a way that information about the status and the progress of the process can be called at any time and without costly preparatory work or terminations.

A further advantage results from the hierarchical structuring of the check points as a result of which information compression in the upward direction and navigation possibilities to problem points in the process are possible. The visualization also includes information compression.

In one advantageous refinement of the invention there is also provision for the information which is evaluated by the check points and which relates to the status and/or progress of the respective process to be used for resource analysis and/or bottleneck analysis.

A computer program component for execution on a correspondingly set up data processing device which has the features of the method according to the invention gives rise to a preferred embodiment of the system according to the invention. A computer program component, in particular a computer program which is stored on a data carrier, and which has the features of the method according to the invention, is therefore expressly included in the disclosed content of the present application.

The invention and advantageous refinements, improvements and further advantages of the invention will be explained and described in more detail by means of the exemplary embodiment illustrated in the figures below.

In the drawing:

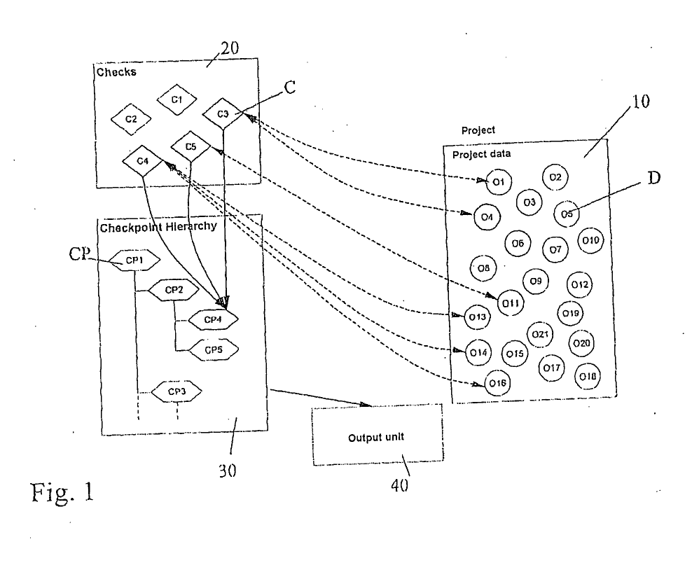

FIG. 1 shows an embodiment of the system according to the invention for analysing and monitoring operations of a technical project,

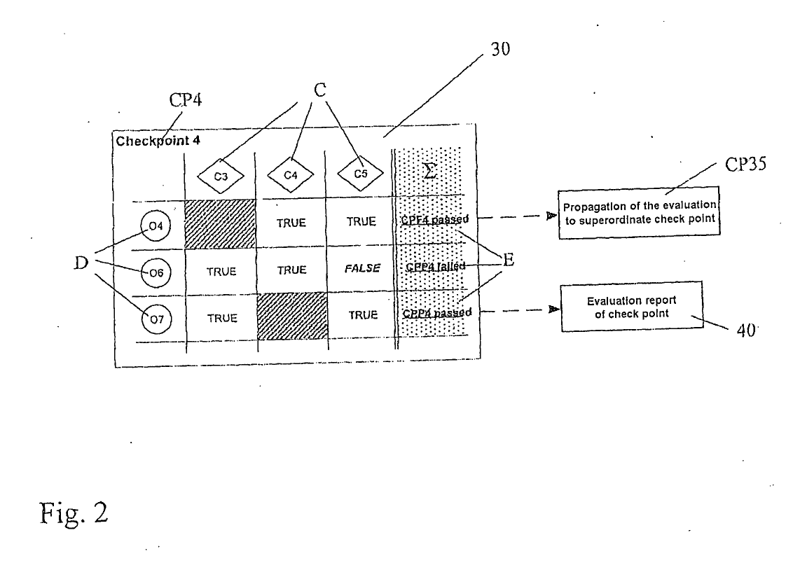

FIG. 2 shows an exemplary check point and the application of check routines to data objects of the technical project,

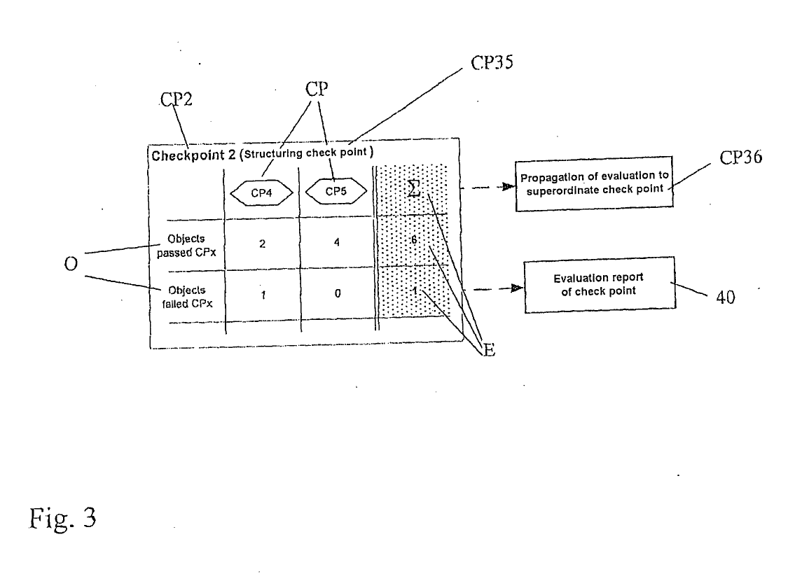

FIG. 3 shows an example of a structured check point and the compression of the information about the status and/or progress of the respective project by means of the structured check point,

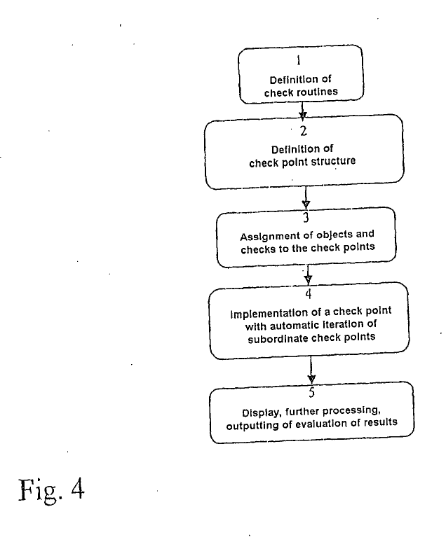

FIG. 4 shows an exemplary, automatically running method sequence which illustrates an embodiment of the system according to the invention.

FIG. 1 shows an exemplary embodiment of the system according to the invention for automatically and systematically analysing and monitoring operations of a technical project 10 for monitoring the status and progress of the project 10, based on data D which characterizes the current state of the project 10 and is referred to below as project data.

The system according to the invention comprises a first module 20 in which check routines C for processing check criteria are defined and stored for evaluation of the project data D.

The first module 20 interacts with a second module 30 which, by assigning the project data D from the project 10, forms hierarchically structured check points CP from the check routines C stored in the first module 20. The hierarchically structured check points CP check the technical completeness of the project data D and generate information about the status and/or progress of the respective project 10 by means of the defined check routines C by taking into account the project data D which is stored in the subordinate check points CP.

After one evaluation, the checked project data D can be displayed by means of an output unit 40 as information about the status and/or progress of the respective project. To do this, the respective check points CP produce an evaluation report which presents the results of the respective check point CP in a compiled form, in particular as a tabular or matrix representation.

FIG. 2 shows the application of the check routines C to data objects O4, O6, O7 of the technical project 10, with a check point CP4 which is integrated into the second module 30 being displayed with the check routines C3, C4, C5 and the project data D as well as the application of the check points C3, C4, C5 to assigned project data D which is compiled to form data objects O4, O5, O6.

The check point CP4 combines the defined check routines C3, C4, C5 and the data objects O4, O5, O6 of the project 10. By assigning the check routines C3, C4, C5 to data objects O4, O5, O6 of the project 10 a definition is made of which check criteria are applied to which data D. During the evaluation of the check point CP4, the check criteria of the check routines C3, C4, C5 are applied to all the assigned objects O4, O5, O6 and the acquired information E about the status and/or progress of the respective project of the check routines C3, C4, C5 is buffered by means of the check point CP4, evaluated for a superordinate check point CP35 and/or transferred as an evaluation report to the evaluation unit 40.

FIG. 2 shows by way of example the second module 30 which is embodied as a table and displays the results of the check routines TRUE, FALSE and the evaluated information E in a compiled and manageable form. The evaluated information E is represented by means of graphic characterization. The use of the graphic characterization facilitates rapid identification of a failed check CPF4 or of the checks CPP4 which have been passed.

The processing and compression of the information of the status and/or progress of the respective project by means of a check point CP35 which is superordinate in the hierarchical structure are shown in FIG. 3.

During the evaluation of the superordinate check point CP35, the information of the subordinate check points CP4, CP5 is applied to all of the assigned objects O of the subordinate check points CPx, and by means of the superordinate check point CP35 the acquired information E of each subordinate check point CP4, CP5 is, as already described in FIG. 2, buffered and evaluated for the subsequent, superordinate check point CP36, compiled and/or transferred as an evaluation report to the evaluation unit 40.

The structured check point CP35 compresses the acquired information E about the status and/or progress of the respective project of the subordinate check points CP4, CP5 and passes on the information E in a compressed form to the next superordinate check point CP36. The results of the structured check point CP35 are visualized by means of the graphic characterization described above using the output unit 40.

FIG. 4 shows an exemplary, automatic method sequence which illustrates an embodiment of the system according to the invention for automatically and systematically analysing and monitoring data D of a process 10.

In a first preparatory step 1, check routines C for the evaluation of the data D which is made available by the process 10 and which is preferably combined to form data objects is defined and stored by means of the first module 20, with the check routines C describing any desired check criteria for the data objects of an industrial process or of a technical project.

In a second step 2, a check point structure for describing check criteria for the evaluation of the data D which is made available by the process 10 is defined and stored on the basis of the check routines C by means of the first module 20.

In a third step 3, the data D which is compiled to form data objects and the associated check routines C are assigned to one another in the check points CP of the second module 30, and in a fourth step 4 the check points CP carry out automatic iteration (evaluation) by taking into account the information from the subordinate check points CP.

In a last step 5, the evaluated information about the current status and/or progress is displayed, further processed or output by means of an output unit 40.

1. System for automatically and systematically analyzing and monitoring operations or sequences of a technical process for the status and progress monitoring of the technical process, based on data which characterizes the current state of the process, in which
check routines for describing and implementing check criteria for evaluating the data are defined and stored in a first module,
the first module interacts with a second module which compiles the check routines stored in the first module to form hierarchically structured check points,
the check routines which are stored in the hierarchically structured check points check, by assigning the data made available by the process and by taking into account the results of the check routines carried out by the subordinate check points, whether the check criteria stored in the check routines apply, carry out automatic evaluation of the check routines and generate information about the status and/or progress of the respective process.

2. System according to claim 1, wherein an output unit is provided which compiles the information about the status and/or progress of the respective process which has been acquired by means of the check points, displays it and/or makes it available for further processing.

3. System according to claim 1, wherein the check points produce an evaluation report for the output unit, which report presents the information about the status and/or progress of the respective process of the respective check point in a compiled form, in particular as a tabular or matrix representation.

4. System according to claim 1, wherein the structure of the check points can be divided into any desired number of hierarchy levels.

5. System according to claim 1, wherein the information about the status and/or progress of the respective process of one or more check points can be called and/or conditioned automatically.

6. System according to claim 1, wherein the check criteria of the check routines check the completeness, the status and/or the properties of objects, documents and/or attributes.

7. System according to claim 1, wherein the check routines are defined independently of the data of the process.

8. System according to claim 1. wherein the check routines check one or more attributes of an object type, the revision of an object type and/or the existence of connections to other objects.

9. System according to claim 1, wherein the process is an industrial process or a technical project.

10. A method for automatically and systematically analyzing and monitoring operations or sequences of a technical process for the status and progress monitoring of the technical process, based on data which characterizes the current state of the process, in which
check routines for describing check criteria for evaluating the data are defined and stored in a first module,
in a second module the check routines stored in the first module are compiled to form hierarchically structured check points,
the check routines which are stored in the hierarchically structured check points check, by assigning the data made available by the process and by taking into account the results of the check routines carried out by the subordinate check points, whether the check criteria structured in the check routines apply, carry out automatic evaluation of the check routines and generate information about the status and/or progress of the respective process.

11. Method according to claim 10, wherein the information about the status and/or progress of the respective process which is acquired by means of the check points is compiled, displayed and/or made available for further processing.

12. Method according to claim 10, wherein an evaluation report which presents the information about the status and/or progress of the respective process of the respective check point in a compiled form, in particular as a tabular or matrix representation, is produced by means of the check points.

13. Method according to claim 10, wherein the structure of the check points is divided into any desired number of hierarchy stages.

14. Method according to claim 10, wherein the information about the status and/or progress of the respective process is called and/or conditioned automatically by means of one or more check points.

15. Method according to claim 10, wherein the completeness, the status and/or the properties of objects, documents, attributes and/or the existence of connections to other objects are checked by means of the check criteria which are stored in the check routines.

16. Method according to claim 10, wherein the check routines are defined independently of the data of the process.

17. System and method according to claim 10, wherein the compression of information and the evaluation of the check points can be carried out under software control and automatically.
